(19) United States
(12) Patent Application Publication
(10) Pub. No.: US 2009/0323274 A1
(43) Pub. Date: Dec. 31, 2009

(54) SERVER

(75) Inventor: Tse-Min Lin, Sijhih City (TW)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: Lanner Electronics Inc., Sijhih City (TW)

(21) Appl. No.: 12/147,336

(22) Filed: Jun. 26, 2008

(51) Int. Cl. G06F 1/20; G06F 1/16

(52) U.S. Cl. 361/679.48; 361/679.47

(57) ABSTRACT

The present invention provides a server, which includes a casing, a transverse plate, a first longitudinal plate, pluralities of first substrate carrier mechanisms and pluralities of substrates. The transverse plate is disposed in the casing, dividing the space within the casing into a first block and a second block. The transverse plate has pluralities of ports, and pluralities of connecting wirings electrically connect these ports. The first longitudinal plate is disposed in the first block, dividing the first block into a first sub-block and a second sub-block. In addition, pluralities of sliding tracks are installed on both sides of the first sub-block. The first substrate carrier mechanisms are piled up in the first sub-block, contacting the sliding tracks in slippery manner. Moreover, pluralities of hard connectors are installed on the substrates, connecting to the ports on the transverse plate.

### BACKGROUND OF THE INVENTION

1. Field of the Invention

The present invention relates to a server. More particularly, the present invention relates to a server composed of several blocks.

2. Description of the Prior Art

In the resent years, the servers are being used in more and more applications due to the improvement of information technology and the popularization of Internet. However, not like the mass market of personal computers, the market of servers is rather small and hard to achieve the efficiency of mass economy due to different dimensions as well as standards that customers require. Moreover, flexible wirings, such as a copper wiring covered by an insulation layer, are used to electrically connect different substrates, costing considerable time to fabricate the servers.

It would, therefore, be desirable to realize the efficiency of mass economy and avoid the complex wirings within the servers.

### SUMMARY OF THE INVENTION

The present invention provides a server which can realize the efficiency of mass economy and avoid the complex wirings therein.

To achieve foregoing and other objects, a server is provided. The server includes a casing, a transverse plate, a first longitudinal plate, pluralities of first substrate carrier mechanisms and pluralities of substrates. The transverse plate is disposed inside the casing, dividing space within the casing into a first block and a second block. There are pluralities of ports disposed on both sides of the transverse plate while connecting wirings disposed inside the transverse plate electrically connect the ports. In addition, the first longitudinal plate is disposed inside the first block, dividing the first block into a first sub-block and a second sub-block. There are pluralities of sliding tracks installed on both sides of the first sub-block. Moreover, the first substrate carrier mechanisms are piled up in the first sub-block and are disposed on the sliding tracks in slippery manner. Furthermore, the substrates are installed on the first substrate carrier mechanisms respectively, and pluralities of hard connectors thereof connect to the ports on the transverse plate.

In the present server, a second longitudinal plate is disposed inside the second block, dividing the second block into a third sub-block and a fourth sub-block. Moreover, at least a sliding track is installed on each side of the third sub-block and the fourth sub-block, while at least a second substrate carrier mechanism is disposed on the sliding tracks in slippery manner.

In the present server, the server further includes a fan assembly, which faces the first substrate carrier mechanisms. In addition, an air guide is installed on each substrate on the first substrate carrier mechanisms, and the air guides are in the corresponding positions with an air vent opening of a fan within the fan assembly.

In the present server, a chip is covered by the air guide or installed in the entrance of the air vent, producing the most heat among all chips on the substrate.

In the present server, pluralities of screws are installed on the first substrate carrier mechanisms, locking the first substrate carrier mechanisms to the casing and the first longitudinal plate, and screw-heads thereof are suitable for users to screw in bare hands.

In the present server, the sliding tracks have pluralities of bulges, which contact the first substrate carrier mechanisms in slippery manner.

In the present server, the casing includes a first casing body and a second casing body, while the second casing body is installed on the first casing body.

When fabricating or maintaining the present server, the users just have to push the substrate carrier mechanisms toward the transverse plate without opening the top cover, plugging hard connectors on the substrates into the ports on the transverse plate so as to electrically connect substrates. Therefore, the time cost to fabricate or maintain the server can be significantly reduced. Besides, different substrate carrier mechanisms can be manufactured in different production liness and then be installed in the server as desired, so as to achieve the efficiency of mass economy. Moreover, the substrates are electrically connected with each other by the hard connectors but flexible wirings. It can, therefore, not only reduce the time cost to fabricate or maintain the server but also make it neat.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a server of the first embodiment of the invention, and FIG. 1B is an enlarged drawing of a screw as shown in FIG. 1A.

FIG. 2A is an inner view of the server of the first embodiment, and FIG. 2B is an enlarged drawing of first port.

FIG. 3 is an inner view of a server when the substrate carrier mechanisms are removed.

FIG. 4 is a partial explosive drawing of a server.

FIG. 5 shows the relationship between the second substrate carrier mechanism and the server.

FIG. 6 shows the relationship between the casing and the casing bodies.

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

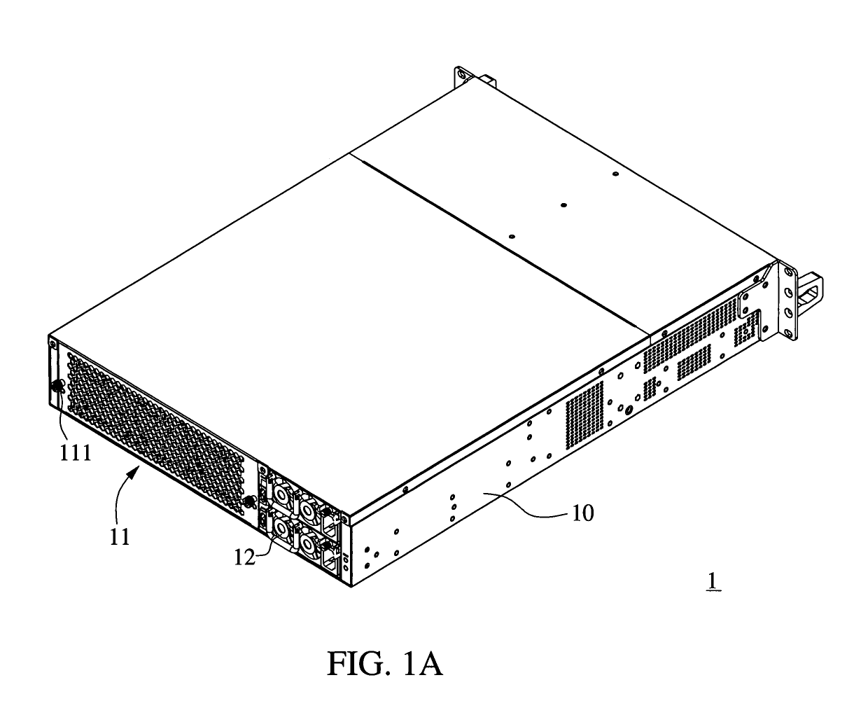

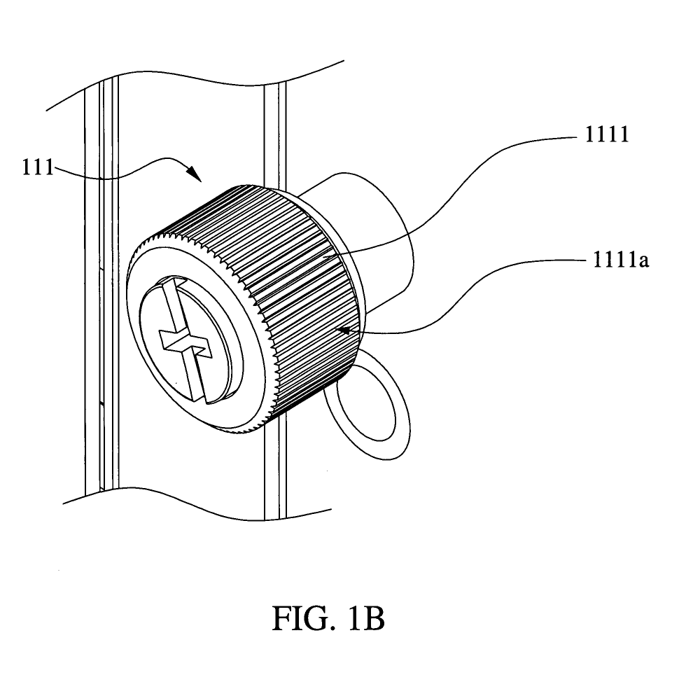

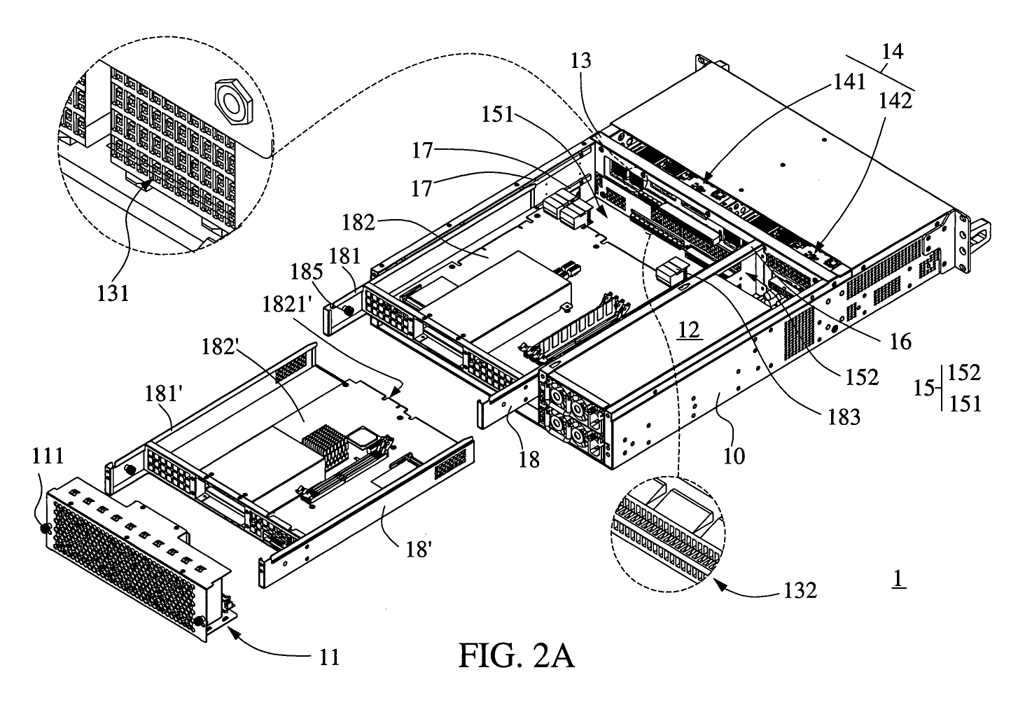

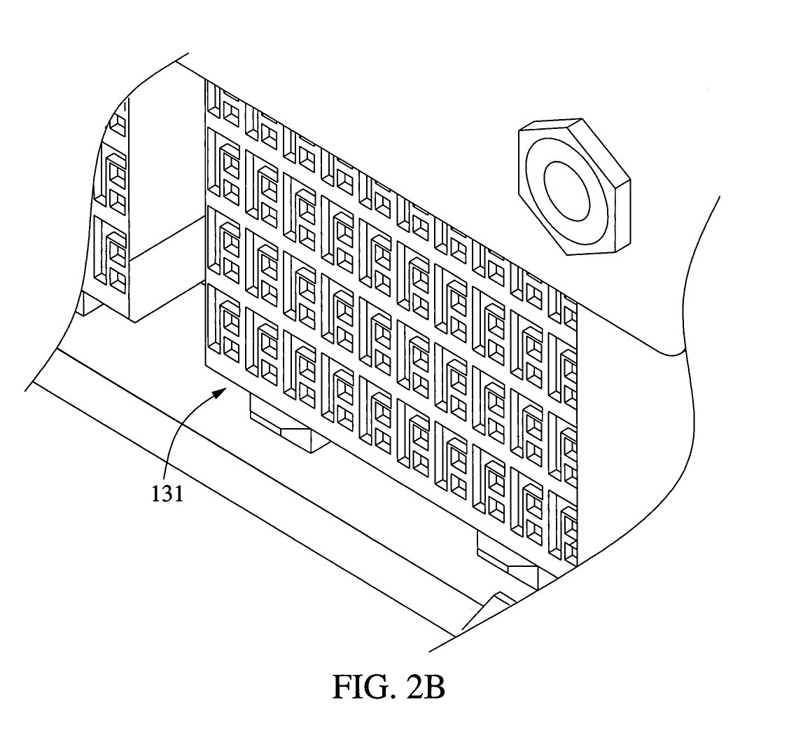

Please refer to FIG. 1A and FIG. 1B simultaneously. FIG. 1A is a server of the first embodiment of the invention, and FIG. 1B is an enlarged drawing of a screw as shown in FIG. 1A. The server 1 is an Internet communication server, for instance. A fan assembly 11 is installed on the rear of the casing 10 of the server 1, locking to the rear end of the first substrate carrier mechanism 18′ (as shown in FIG. 2A) by two screws 111. The side surface of the screw-head 1111 of the screws 111 has pluralities of grooves 1111a to increase the friction between the screw-head 1111 and fingers, so as to allow users to screw in bare hands without any help of a screwdriver.

Now, please refer to FIG. 1A and FIG. 2A simultaneously. FIG. 2A is an inner view of the server of the first embodiment. The transverse plate 13 is further installed inside the server 1, dividing the space within the casing 10 into a first block 15 and a second block 14. In addition, a first longitudinal plate 16 is installed inside the first block 15, dividing the first block 15 into a first sub-block 151 and a second sub-block 152. Moreover, there are pluralities of different ports, such as the first port 131 and the second port 132, disposed on the transverse plate 13. Furthermore, connecting wirings (not depicted) are installed inside the transverse plate 13, electrically connecting different ports thereby.

Pluralities of sliding tracks 17 are disposed on both sides of the first sub-block 151, so as to let the first substrate carrier mechanism 18 slide thereon. The first substrate carrier mechanism 18 is disposed inside the casing 10 and has sliding edges 181 on both sides thereof. The sliding edges 181 contact the sliding tracks 17 in slippery manner, so as to allow users to push and pull the first substrate carrier mechanism 18 back and forth on the sliding tracks 17.

Please refer to FIG. 2B for an enlarged drawing of first port. The first port 131 has pluralities of sockets. Next, please refer to FIG. 2A and FIG. 2B simultaneously. Substrates 182 and 183 are installed on the first substrate carrier mechanism 18 and 18′ respectively. The substrate 182 has pluralities of hard connectors 183, which have pluralities of pins to be plugged into the sockets of the first ports 131. Moreover, a metal thin plate (not depicted) can be disposed on the protruding rim of the substrate 182′ to form a hard connector 1821′, which can connect to the second port 132 on the transverse plate 13. When the first substrate carrier mechanism 18 is plugged into the casing 10, the users can lock the first substrate carrier mechanism 18 to the casing 10 as well as the first longitudinal plate 16. The structure of the screw 185 is identical to that of the screw 111, and accordingly, it is not depicted again.

Due to the disposal of the hard connectors, the users just have to push the first substrate carrier mechanisms 18 and 18′ toward the transverse plate 13, plugging the hard connector 183 on the substrate 182 and the hard connector 1821′ on the substrate 182′ into the ports on the transverse plate 13, so as to electrically connect substrates 182 and 182′. Therefore, the time cost to fabricate the server 1 can be considerably reduced. Besides, different first substrate carrier mechanisms 18 can be manufactured in different production lines and then installed in the server 1 as desired, so as to achieve the efficiency of mass economy. Moreover, the substrates 182 and 182′ are electrically connected with each other by the hard connectors but flexible wirings. It can, therefore, not only reduce the time cost to fabricate the server 1 but also make it neat.

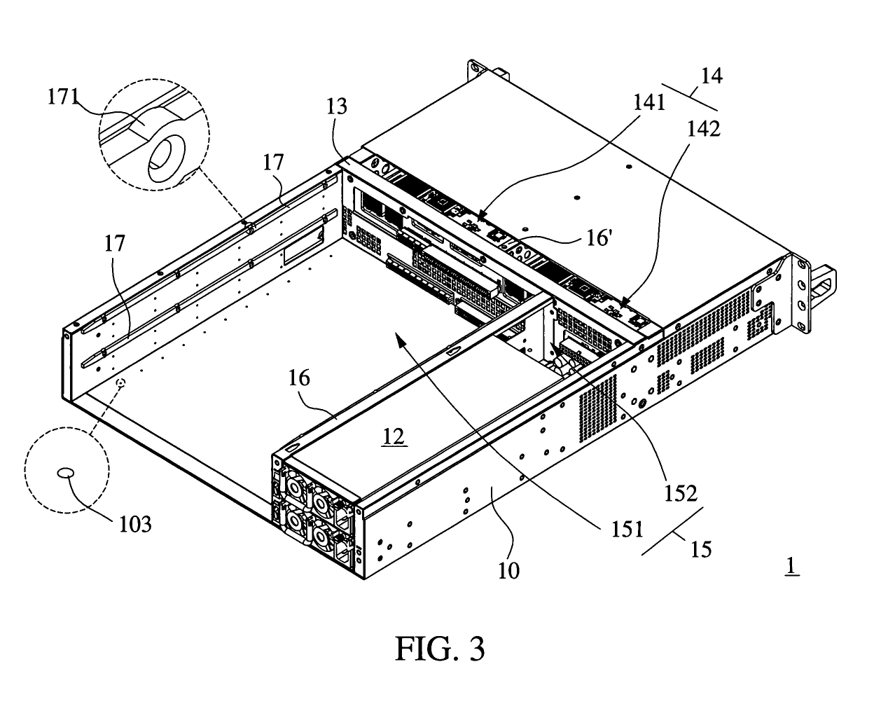

Next, the structure of the sliding tracks 17 is disclosed hereinbelow. Please refer to FIG. 2A and FIG. 3 simultaneously. FIG. 3 is an inner view of a server when the substrate carrier mechanisms are removed. As shown in FIG. 3, the sliding tracks 17 have pluralities of bulges 171, which are disposed at intervals along the sliding tracks 17. When the first substrate carrier mechanism 18 is installed in the server 1, the sliding edges 181 contact the bulges 171 in slippery manner. The disposal of the bulges 171 can reduce the friction index, and therefore the friction, between the first substrate carrier mechanism 18 and the sliding tracks 17. In addition, the bottom of the casing 10 has bulges 103. Besides the fact that the sliding edges 181′ of the first substrate carrier mechanism 18′ contact the bulges 171 in slippery manner when the first substrate carrier mechanism 18′ is installed in the server 1, the bottom of the first substrate carrier mechanism 18′ also contact the bulges 103 in slippery manner, therefore reducing the friction between the first substrate carrier mechanism 18′ and the casing 10.

However, there is no need to install sliding tracks 17 in every sub-block. In the present embodiment, there is no sliding track installed in the second sub-block 152 while a power supply 12 for use of the server 1 is disposed therein. Moreover, in the present embodiment, there are two substrate carrier mechanisms, which means the first substrate carrier mechanisms 18 and 18′ here, piled up within the first sub-block 151, yet those skilled in the art can also enlarge the height of the casing 10 and dispose more sliding tracks 17 to pile more substrate carrier mechanisms therein.

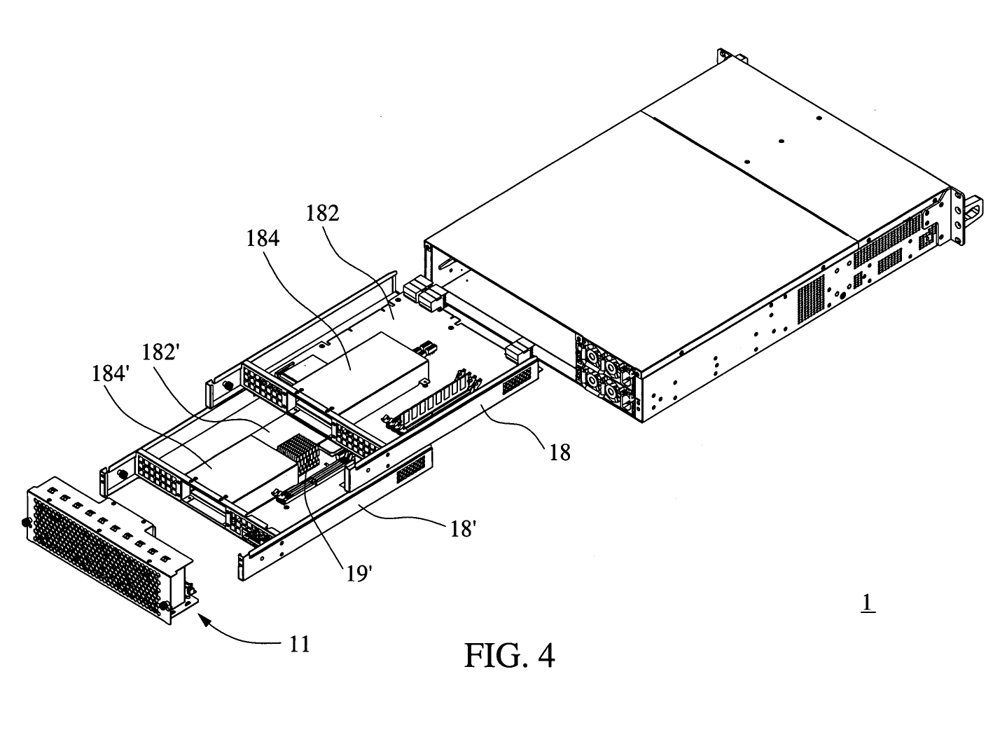

Please refer to FIG. 4 for a partial explosive drawing of a server. In the present embodiment, there are three fans, such as drawing fans, installed in the fan assembly 11. Meanwhile, a first air guide 184 and a second air guide 184′ are placed on the substrates 182 and 182′ respectively. In the present embodiment, the first air guide 184 and the second air guide 184′ are in the corresponding positions with the middle fan within the fan assembly 11. That is to say, the first air guide 184 and the second air guide 184′ are in the air vent opening. Since the disposal of air guides can increase the effect of convection, the chip covered by the first air guide 184, the second air guide 184′ or in the entrance of the first air guide 184, the second air guide 184′ usually produces the most heat among all chips on the substrate 182 or 182′. For instance, the chip installed under the heat sink 19′ produces the most heat among all chips on the substrate 182′, and it is disposed in the entrance of the second air guide 184′.

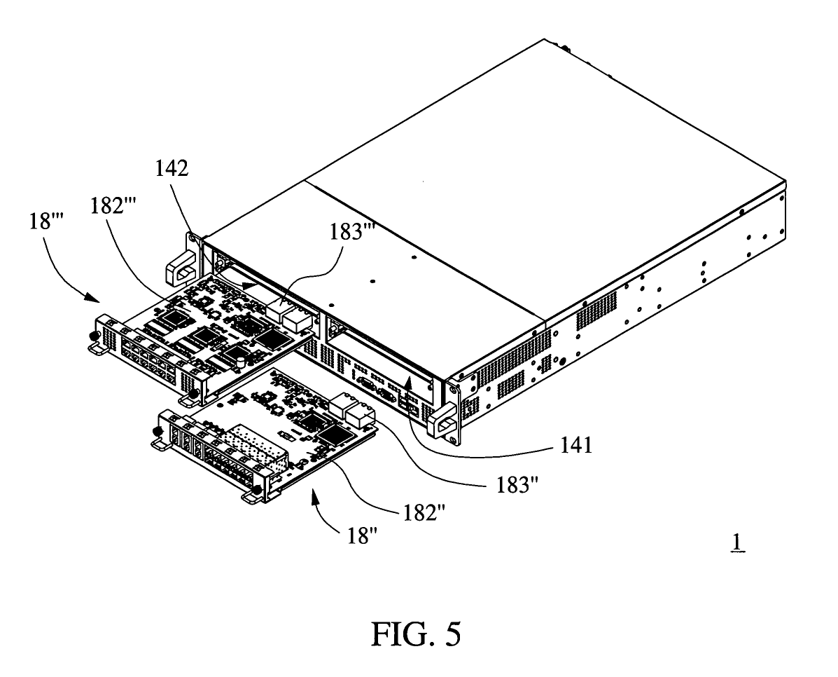

Next, please refer to FIG. 3 and FIG. 5. FIG. 5 shows the relationship between the second substrate carrier mechanism and the server. The second longitudinal plate 16′ is disposed inside the second block 14, dividing the second block 14 into a third sub-block 141 and a fourth sub-block 142. Both the third sub-block 141 and the fourth sub-block 142 have sliding tracks similar to the sliding tracks 17 in the first sub-block 151 disclosed hereinabove. Therefore, the users can push the second substrate carrier mechanisms 18″ and 18′″ into the server 1 in slippery manner. In addition, a hard connector 183″ and a hard connector 183′″ are disposed on the substrates 182″ and 182′″ respectively, so as to connect to the ports on the transverse plate 13 when the substrates 182″ and 182′″ are pushed into the server 1. In the present embodiment, there is only one sliding track on each side of the third sub-block 141 and the fourth sub-block 142. However, those skilled in the art can also enlarge the height of the third sub-block 141 and the fourth sub-block 142 and install more sliding tracks as desired, so as to install more second substrate carrier mechanisms in the third sub-block 141 and the fourth sub-block 142 in slippery manner.

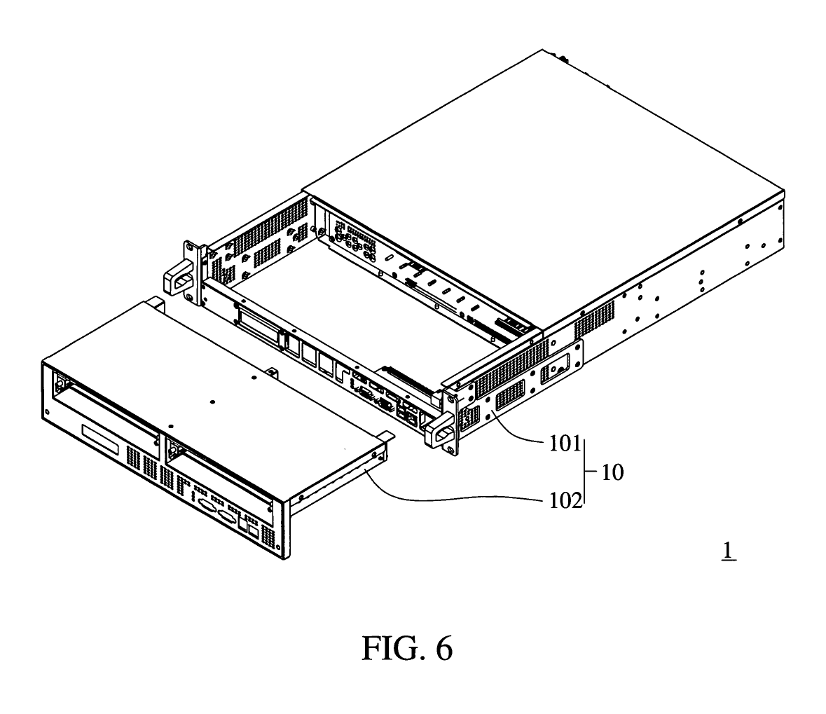

Please refer to FIG. 5 and FIG. 6. FIG. 6 shows the relationship between the casing and the casing bodies. As shown in FIG. 6, the casing 10 includes a first casing body 101 and a second casing body 102, while the second casing body 102 is installed on the first casing body 101. Therefore, the manufacturers can fabricate the second substrate carrier mechanisms onto the second casing 102 in another production line, and then install the second casing 102 on the first casing 101.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

I claim:

1. A server, comprising:
a casing;
a transverse plate, disposed inside the casing, dividing space within the casing into a first block and a second block, and pluralities of ports disposed on both sides of the transverse plate while connecting wirings disposed inside the transverse plate electrically connecting the ports;
a first longitudinal plate, disposed inside the first block, dividing the first block into a first sub-block and a second sub-block, wherein there are pluralities of sliding tracks installed on both sides of the first sub-block;
pluralities of first substrate carrier mechanisms, piled up in the first sub-block and disposed on the sliding tracks in slippery manner; and
pluralities of substrates, installed on the first substrate carrier mechanisms respectively, wherein the substrates have pluralities of hard connectors to connect to the ports on the transverse plate.

2. The server according to claim 1, wherein a second longitudinal plate is disposed inside the second block, dividing the second block into a third sub-block and a fourth sub-block.

3. The server according to claim 2, wherein at least a sliding track is installed on each side of the third sub-block and the fourth sub-block, while at least a second substrate carrier mechanism is disposed on the sliding tracks in slippery manner.

4. The server according to claim 1, wherein the server further comprises a fan assembly, which faces the first substrate carrier mechanisms.

5. The server according to claim 4, wherein an air guide is installed on each said substrate on the first substrate carrier mechanisms, and the air guide and an air vent opening of a fan within the fan assembly are in the corresponding positions.

6. The server according to claim 5, wherein a chip is covered by the air guide or installed in the entrance of the air vent, producing the most heat among all chips on the substrate.

7. The server according to claim 1, wherein pluralities of screws are installed on the first substrate carrier mechanisms, locking the first substrate carrier mechanisms to the casing and the first longitudinal plate, and screw-heads thereof are suitable for users to screw in bare hands.

8. The server according to claim 1, wherein the sliding tracks have pluralities of bulges, which contact the first substrate carrier mechanisms in slippery manner.

9. The server according to claim 1, wherein the casing comprises a first casing body and a second casing body, and the second casing body is installed on the first casing body.
